(19) United States
(12) Patent Application Publication
(10) Pub. No.: US 2015/0175738 A1
(43) Pub. Date: Jun. 25, 2015

(54) PROCESSING-FRIENDLY DIANHYDRIDE HARDENER FOR EPOXY RESIN SYSTEMS BASED ON 5,5'-OXYBIS(ISOBENZOFURAN-1,3-DIONE)

(71) Applicants: Benjamin WILLY, Duesseldorf (DE); Manfred Neumann, Marl (DE)

(72) Inventors: Benjamin WILLY, Duesseldorf (DE); Manfred Neumann, Marl (DE)

(73) Assignee: EVONIK INDUSTRIES AG, Essen (DE)

(21) Appl. No.: 14/575,331

(22) Filed: Dec. 18, 2014

(30) Foreign Application Priority Data
Dec. 19, 2013 (DE) 102013226613.8

(51) Int. Cl. C08G 59/16

(52) U.S. Cl. CPC C08G 59/1455

(57) ABSTRACT

The present invention provides a composition comprising 5,5′-oxybis(isobenzofuran-1,3-dione), 4,4′-oxybis(ortho-phthalic acid) and at least one monoanhydride compound selected from the group consisting of methylhexahydroisobenzofuran-1,3-dione, 5-methyl-3a,4,7,7a-tetrahydro-4,7-methanoisobenzofuran-1,3-dione, 5-methyl-3 a,4,7,7a-tetrahydroisobenzofuran-1,3-dione, 3-methylfuran-2,5-dione, 3,3,4,4,5,5-hexafluorodihydro-2H-pyran-2,6(3H)-dione, and 3,3-dimethyldihydrofuran-2,5-dione. The invention also provides a hardener system for epoxy resins, said hardener system comprising said composition. The invention also provides a method for hardening of epoxy resins employing the inventive composition.

### CROSS REFERENCE TO RELATED APPLICATIONS

This application claims priority to German Application No. 102013226613.8 filed Dec. 19, 2013, the disclosure of which is incorporated herein by reference in its entirety.

### BACKGROUND OF THE INVENTION

The present invention relates to a composition comprising

a. 5,5′-oxybis(isobenzofuran-1,3-dione);

b. 4,4′-oxybis-(ortho-phthalic acid); and

c. at least one monoanhydride compound selected from the group consisting of methylhexahydroisobenzofuran-1,3-dione, 5-methyl-3a,4,7,7a-tetrahydro-4,7-methanoisobenzofuran-1,3-dione, 5-methyl-3a,4,7,7a-tetrahydroisobenzofuran-1,3-dione, 3-methylfuran-2,5-dione, 3,3,4,4,5,5-hexafluorodihydro-2H-pyran-2,6(3H)-dione, 3,3-dimethyldihydrofuran-2,5-dione.

The invention also relates to a hardener system for epoxy resins, said hardener system comprising said composition. The invention also relates to the use of said hardener system for hardening of epoxy resins and to corresponding methods.

Epoxy resins are one of the most versatile polymeric materials. They find uses, for example, as coatings, adhesives, casting resin compounds, moulding compounds, as embedding compounds for encasing electronic components, as laminates and base material for printed circuits, and as matrix resins for fibre-reinforced plastics.

The conversion of monomeric or polymeric epoxy resins to polymeric substances requires co-reactants, which are referred to as hardeners or hardening agents. According to the hardener type, the hardening reaction is effected at temperatures around room temperature or low temperatures (called “cold curing”) or at elevated temperatures (called “warm or hot curing”). For hardening of epoxy resins at low temperatures for industrial applications, predominantly only aliphatic primary or secondary amines and polyamines are used; less commonly used, in contrast, are polythiols or specific salts.

All unmodified amines are alkaline to strongly alkaline. Liquid amines, especially the aliphatic and cycloaliphatic amines, can cause skin damage extending as far as chemical burns. Another disadvantage is the high volatility of the liquid amines. A great disadvantage of the cold curing of epoxy resins with the abovementioned hardening agents is the low thermal resistance and chemical resistance of the resultant products. To increase the thermal stability, solvent stability and chemical stability, one is forced to harden epoxy resins at elevated temperatures in a hot curing operation with aromatic or cycloaliphatic amines, carboxylic anhydrides, polyphenols, or with latent hardeners.

However, there is a demand for epoxy resin hardener systems which can harden at minimum temperature and give rise to products having an elevated thermal stability, chemical stability and solvent stability. Potential applications for these are, for example, adhesives, matrix resins for fibre composites and repair resins for components where the employment of high temperatures is not an option. Further applications are casting resin and embedding compounds, specifically for encasing of large electronic components, where the hardening can proceed at low temperature, with low exothermicity and consequently with a considerable energy saving, a further advantage being that products with reduced internal stress are the result.

It is conventionally known that the hardening of epoxy resins, especially in the case of bisphenol A resins, with cyclic dicarboxylic anhydrides and tetracarboxylic bisanhydrides requires hardening temperatures of at least 120-150° C., in which case hardening times of several hours are required; see Houben-Weyl, Methoden der Organischen Chemie [Methods of Organic Chemistry], volume E20, Makromolekulare Stoffe [Macromolecular Substances], Georg Thieme Verlag Stuttgart, 1987, page 1959. Even at these temperatures, the crosslinking reaction is still so slow that it is generally not possible to avoid using accelerators. It is advantageous, however, that the hardening with anhydrides proceeds with lower exothermicity compared to hardening with amines. The hardened products have good electrical insulation properties and good thermal stability.

U.S. Pat. No. 4,002,599 describes hardening of epoxy resins with cyclic acid anhydrides at low temperatures. However, only systems based on polyglycidyl-substituted aminophenols are described.

DE 2837726 describes epoxy resin compositions composed of at least one epoxy resin and a hardening agent, said hardening agent comprising 2,3,3′,4′-diphenyltetracarboxylic anhydride. According to the teaching of DE 2837726, the anhydride first has to be dissolved before hardening can be effected; in some cases, the mixture is even cooled down again. This can lead to problems; more particularly, the hardening agent can separate out.

An additional disadvantage is the need, described in the prior art, to utilize a catalyst for hardening and therefore to be reliant particularly on the use of amines. The above-discussed irritant effect of the aliphatic and cycloaliphatic amines can be alleviated somewhat by use of aromatic amines as catalysts, as described in U.S. Pat. No. 3,989,573, where 2-ethyl-4-methylimidazole was used. However, it would be even more desirable to be able to entirely dispense with the use of such catalysts and nevertheless to be able to obtain such polymerization rates as would enable the use of the hardener systems.

In addition, there is the need to have available a user-friendly hardener system. Thus, many hardener systems which are composed of a dianhydride compound and a monoanhydride compound have the problematic property of being in the form of a fine-dusting powder over a wide mixing range of the two components, which makes them difficult to process and makes the addition of solvents unavoidable. Such an addition of solvents again prevents formulation of the desired hardener system in a high concentration, i.e. with a minimum level of other substances. For use as a hardener system, however, it is precisely such high concentrations that should not be present in powder form that are desired. Furthermore, it is disadvantageous when the solid is present in excessively dilute form, since settling of the solid then sets in within a few hours, which leads to unwanted inhomogeneities in the composition.

It is therefore also desirable to obtain a non-dusting formulation which is stable and storable over a wide mixing range.

It is therefore an object of the present invention to provide an improved hardener system for the hardening of epoxy resins. This hardener system shall be easy to process and, after hardening, lead to resin systems—even without the use of the conventional catalysts mentioned—with a good, lasting heat distortion resistance. At the same time, the system shall allow good formulatability over a wide concentration range of the dianhydride compound and monoanhydride compound, and at the same time be storable with respect to homogeneity. Finally, the use of catalysts composed of amine compounds or metal salts shall also be avoided, and a good polymerization rate shall nevertheless be achievable.

### SUMMARY OF THE INVENTION

These and other objects have been achieved according to the present invention, the first embodiment of which includes a composition comprising:

5,5′-oxybis(isobenzofuran-1,3-dione);

4,4′-oxybis(ortho-phthalic acid); and

a monoanhydride compound selected from the group consisting of methylhexahydroisobenzofuran-1,3-dione, 5-methyl-3a,4,7,7a-tetrahydro-4,7-methanoisobenzofuran-1,3-dione, 5-methyl-3a,4,7,7a-tetrahydroisobenzofuran-1,3-dione, 3-methylfuran-2,5-dione, 3,3,4,4,5,5-hexafluorodihydro-2H-pyran-2,6(3H)-dione and 3,3-dimethyldihydrofuran-2,5-dione.

In another embodiment, the present invention includes a hardener system for epoxy resins, comprising the composition according to the first embodiment, wherein a proportion by mass of the composition is from 10% to 100% by mass, based on the total mass of the hardener system.

In a further embodiment, the present invention provides a method for hardening an epoxy resin, comprising mixing the hardener system according the invention with the epoxy resin to be hardened.

The foregoing paragraphs have been provided by way of general introduction, and are not intended to limit the scope of the following claims. The described embodiments, together with further advantages, will be best understood by reference to the following detailed description.

### DETAILED DESCRIPTION OF THE PREFERRED EMBODIMENTS

In the following description, the words “a” and “an” and the like carry the meaning of “one or more.” The phrases “selected from the group consisting of,” “chosen from,” and the like include mixtures of the specified materials. Terms such as “contain(s)” and the like are open terms meaning ‘including at least’ unless otherwise specifically noted. Where a numerical limit or range is stated, the endpoints are included. Also, all values and subranges within a numerical limit or range are specifically included as if explicitly written out.

The inventors have surprisingly and unexpectedly found that addition of 4,4′-oxybis-(ortho-phthalic acid) (“OTA” hereinafter) to the hardener to accelerate the polymerization achieves the objects of the invention as described above.

Thus in a first embodiment the present invention provides

1. a composition comprising

a. 5,5′-oxybis(isobenzofuran-1,3-dione) (“OPDA” hereinafter);

b. 4,4′-oxybis-(ortho-phthalic acid); and

c. at least one monoanhydride compound selected from the group consisting of methylhexahydroisobenzofuran-1,3-dione (“MHHPSA” hereinafter), 5-methyl-3a,4,7,7a-tetrahydro-4,7-methanoisobenzofuran-1,3-dione (“MNA” hereinafter), 5-methyl-3a,4,7,7a-tetrahydroisobenzofuran-1,3-dione (“MTHPA” hereinafter), 3-methylfuran-2,5-dione (“MFD” hereinafter), 3,3,4,4,5,5-hexafluorodihydro-2H-pyran-2,6(3H)-dione (“HFDPA” hereinafter), and 3,3-dimethyldihydrofuran-2,5-dione (“DMDF” hereinafter”).

In a further embodiment of the present invention, the composition according to the first embodiment is characterized in that the monoanhydride compound is selected from the group consisting of MHHPSA, MTHPA, MNA; preferably selected from the group consisting of MTHPA, MNA and in one preferred aspect the monoanhydride compound is MTHPA.

In a further embodiment of the present invention, the composition according to the above description is characterized in that the ratio of the mass of OPDA in the composition to the sum total of the mass of MHHPSA, the mass of MNA, the mass of MTHPA, the mass of MFD, the mass of HFDPA, the mass of DMDF in the composition is 1:0.250 to 1:1.900, preferably 1:0.309 to 1:1.856, more preferably 1:0.412 to 1:1.546.

In a further embodiment of the present invention, the composition is characterized in that the mass of OTA in the composition is 0.01 to 16.9% of the sum total of the mass of OPDA, the mass of MHHPSA, the mass of MNA, the mass of MTHPA, the mass of MFD, the mass of HFDPA, and the mass of DMDF in the composition.

In a further embodiment, the present invention provides a hardener system for epoxy resins, comprising the composition according to the above description in a proportion by mass of 0.10 to 1.0, based on the total mass of the hardener system. According to the invention the hardener system for epoxy resins may not include any amine compound and further a metal salt may not be included.

In a further embodiment, the present invention relates to an epoxy resin system comprising an epoxy resin and at least one hardener system according to the above description.

The present invention provides a composition consisting of

a. OPDA;

b. OTA; and

c. at least one monoanhydride compound selected from the group consisting of MHHPSA, MNA, MTHPA, MFD, HFDPA, DMDF, preferably from the group consisting of MHHPSA, MTHPA, MNA; most preferably selected from the group consisting of MTHPA, MNA and most preferred the monoanhydride compound is MTHPA.

In this composition the ratio of the mass of OPDA in the composition to the sum total of the mass of MHHPSA, the mass of MNA, the mass of MTHPA, the mass of MFD, the mass of HFDPA, and the mass of DMDF in the composition is 1:0.250 to 1:1.900, preferably 1:0.309 to 1:1.856, more preferably 1:0.412 to 1:1.546.

In a further embodiment of the present invention, the composition is characterized in that the mass of OTA in the composition is 0.01 to 16.9% of the sum total of the mass of OPDA, the mass of MHHPSA, the mass of MNA, the mass of MTHPA, the mass of MFD, the mass of HFDPA, and the mass of DMDF in the composition.

In a further embodiment, the present invention provides a hardener system for epoxy resins, comprising the composition described in the previous paragraph in a proportion by mass of 0.10 to 1.0, based on the total mass of the hardener system. This system may not include any amine compound and may not include any metal salt.

The present invention further provides a method for hardening epoxy resins, wherein

a. in a first step at least one epoxy resin is mixed with

i. OPDA; and

ii. at least one monoanhydride compound selected from the group consisting of MHHPSA, MNA, MTHPA, MFD, HFDPA, DMDF;

b. in a second step OTA is added; and

c. in a third step the epoxy resin is hardened at a temperature of at least 25° C.

In another method embodiment the present invention provides a method for hardening epoxy resins, wherein

a. in a first step

i. OPDA; and

ii. OTA; and

iii. at least one monoanhydride compound selected from the group consisting of MHHPSA, MNA, MTHPA, MFD, HFDPA, DMDF

are mixed;

b. in a second step at least one epoxy resin is added; and

c. in a third step the epoxy resin is hardened at a temperature of at least 25° C.

In a further aspects of these embodiments the hardening of the epoxy resin is effected in the range from 25° C. to below the melting temperature of the OPDA, which is within the range of 225° C. to 229° C.

Thus, in the first embodiment the present invention provides a composition comprising:

5,5′-oxybis(isobenzofuran-1,3-dione);

4,4′-oxybis(ortho-phthalic acid); and

a monoanhydride compound selected from the group consisting of methylhexahydroisobenzofuran-1,3-dione, 5-methyl-3a,4,7,7a-tetrahydro-4,7-methanoisobenzofuran-1,3-dione, 5-methyl-3a,4,7,7a-tetrahydroisobenzofuran-1,3-dione, 3-methylfuran-2,5-dione, 3,3,4,4,5,5-hexafluorodihydro-2H-pyran-2,6(3H)-dione and 3,3-dimethyldihydrofuran-2,5-dione.

More particularly, the monoanhydride compound in the inventive composition is selected from the group consisting of MHHPSA, MTHPA, MNA. More preferably, the monoanhydride compound in the inventive composition is selected from the group consisting of MTHPA, MNA. Even more preferably, the monoanhydride compound in the inventive composition is MTHPA.

The structural formulae of the respective compounds are as follows:

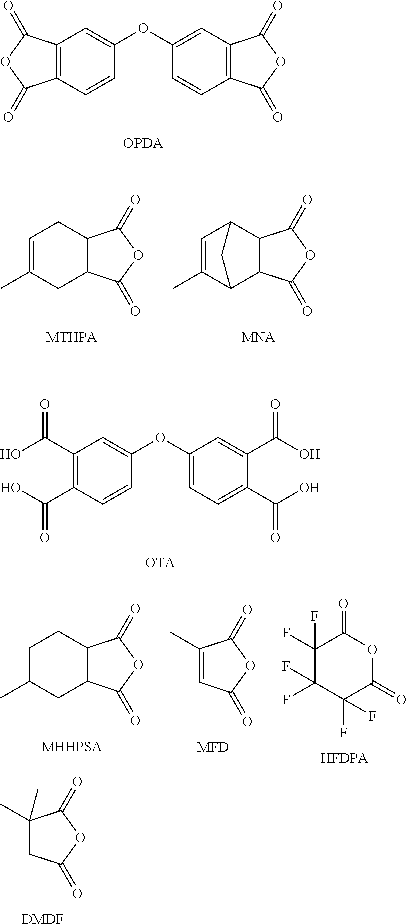

As is apparent from the examples, it is a feature of the inventive composition that it polymerizes more quickly because of the presence of OTA and can thus also be used as a hardener for epoxy resins. In this way, it is possible to dispense with the use of highly corrosive amine compounds as catalysts. Equally, this also makes it possible to dispense with the use of metal salts for catalysis, which is advantageous particularly in industrial scale plants, since metal salts are deposited therein and typically lead to corrosion of plant components.

In an advantageous embodiment of the present invention, the ratio of the mass of OPDA in the inventive composition to the sum total of the mass of MHHPSA, the mass of MNA, the mass of MTHPA, the mass of MFD, the mass of HFDPA, and the mass of DMDF in the inventive composition is 1:0.250 to 1:1.900, preferably 1:0.309 to 1:1.856, more preferably 1:0.412 to 1:1.546.

It will be appreciated that the expression “sum total of the mass of MHHPSA, the mass of MNA, the mass of MTHPA, the mass of MFD, the mass of HFDPA, the mass of DMDF”, when it is abbreviated to “Σₘₒₙₒ”, can be represented mathematically as

Σₘₒₙₒ=m_{MHHPSA}+m_{MNA}+m_{MTHPA}+m_{MFD}+m_{HFDPA}+m_{DMDF}

where

m_{MHHPSA}=mass of MHHPSA in grams;

m_{MNA}=mass of MNA in grams;

m_{MTHPA}=mass of MTHPA in grams;

m_{MFD}=mass of MFD in grams;

m_{HFDPA}=mass of HFDPA in grams;

m_{DMDF}=mass of DMDF in grams.

Compliance with these preferred mass ratios allows a user-friendly and storage-stable composition to be obtained. This is because, in the case of compliance with these mass ratios, the inventive composition can be processed and used efficiently, since it does not form dust. On the other hand, the settling of the heavier particles in the composition may be prevented, as a result of which no inhomogeneities arise. As is apparent from the experiments, this is possible in the case of the inventive composition over a wide range of mass ratios of OPDA based on the sum total of the mass of MHHPSA, MNA, MTHPA, MFD, HFDPA and DMDF in the composition. Incidentally, it has been observed that a mixture of the OPDA and MTHPA, compared to a mixture of OPDA and MNA, exhibits these advantageous properties over a broad range of possible mass ratios. This was additionally completely surprising.

The amount of OTA used in the inventive composition is not particularly restricted. In a particularly advantageous embodiment, the mass of OTA in the composition is 0.01 to 16.9% of the sum total of the mass of OPDA, the mass of MHHPSA, the mass of MNA, the mass of MTHPA, the mass of MFD, the mass of HFDPA, the mass of DMDF in the composition. Preferably, the mass of OTA in the composition is 0.025 to 10% of the sum total of the mass of OPDA, the mass of MHHPSA, the mass of MNA, the mass of MTHPA, the mass of MFD, the mass of HFDPA, and the mass of DMDF in the composition. Even more preferably, the mass of OTA in the composition is 0.05 to 5% of the sum total of the mass of OPDA, the mass of MHHPSA, the mass of MNA, the mass of MTHPA, the mass of MFD, the mass of HFDPA, the mass of DMDF in the composition. Most preferably, the mass of OTA in the composition is 0.05 to 3% of the sum total of the mass of OPDA, the mass of MHHPSA, the mass of MNA, the mass of MTHPA, the mass of MFD, the mass of HFDPA, the mass of DMDF in the composition.

The expression “sum total of the mass of OPDA, the mass of MHHPSA, the mass of MNA, the mass of MTHPA, the mass of MFD, the mass of HFDPA, the mass of DMDF”, when it is abbreviated to “Σ_{mono+OPDA}”, can be represented mathematically as

Σ_{mono+OPDA}=m_{OPDA}+Σₘₒₙₒ

where m_{OPDA} indicates the mass of OPDA in grams and Σₘₒₙₒ is as defined above.

The inventive composition may be used particularly in hardener systems, preferably those for epoxy resins.

The invention thus relates, in a further aspect, to a hardener system for epoxy resins, comprising the inventive composition.

It will be appreciated that the inventive hardener system, apart from the OPDA, the OTA, the MHHPSA, the MNA, the MTHPA, the MFD, the HFDPA, the DMDF in the inventive composition, does not contain any more OPDA, OTA, MHHPSA, MNA, MTHPA, MFD, HFDPA, DMDF.

The inventive hardener system includes the inventive composition in a proportion by mass of 0.10-1.0, preferably 0.20-0.999, more preferably 0.40-0.90, most preferably 0.50-0.85, based in each case on the total mass of the hardener system.

The inventive hardener system may additionally also include further additives, for example lubricants, antiblocking agents, release agents, stabilizers, for example antioxidants, light stabilizers, heat stabilizers or foam stabilizers, antistats, conductive additives, flame retardants, pigments, impact modifiers, flexibilizers, plasticizers, adhesion promoters, fillers, for example carbon black, calcium carbonate, talc, silicates, cotton wool, synthetic polymers, metal powders, graphite or glass fibres, reinforcing materials, blowing agents, kickers, nucleating agents, antibacterial agents or fungicides. All substances which are known to those skilled in the art to be suitable additives for production of epoxy resin systems may be used as the additives mentioned.

It is a feature of the inventive hardener system that it is possible to dispense with the use of an amine compound or of a metal salt as catalyst. It is therefore preferable that the inventive hardener system does not include any such catalysts. Of course, the inventive hardener system may nevertheless also be used in combination with such a catalyst.

In the context of the invention, an “amine compound” is selected from the group consisting of amines, phenolic amines and cycloaliphatic or aromatic N-heterocycles.

“Amines” in the context of the invention are N¹,N¹-dimethylpropane-1,3-diamine (DMAPA), N¹,N¹,N³,N³-tetramethylpropane-1,3-diamine, N¹,N¹,N²,N²-tetramethylethane-1,2-diamine, N,N-dimethyl-1-benzylamine, N,N-diethyl-1-benzylamine, triethylamine, tripropylamine, diisopropylethylamine, 2-dimethylaminoethanol or 2-diethylaminoethanol.

“Cycloaliphatic or aromatic N-heterocycles” in the context of the invention are pyrrolidine, piperidine, 1-benzylpiperidine, piperazine, 1,4-dimethylpiperazine, 2,2,6,6-tetramethylpiperidine, 2,2,6,6-tetramethylpiperidine-4-amine, N-alkyl-2,2,6,6-tetramethylpiperidine-4-amine, N¹,N¹-dimethyl-N³-(2,2,6,6-tetramethylpiperidin-4-yl)propane-1,3-diamine, 2,2,6,6-tetramethylpiperidin-4-ol, 1,2,2,6,6-pentamethylpiperidin-4-ol, 4-alkoxy-2,2,6,6-tetramethylpiperidine, N¹,N⁶-bis(2,2,6,6-tetramethylpiperidin-4-yl)hexane-1,6-diamine, 1H-pyrrole, 1H-imidazole, 1-methyl-1H-imidazole (1MZ), 3-(2-ethyl-4-methyl-1H-imidazol-1-yl)propanenitrile (2E4MZ-CN), 2-ethyl-4-methyl-1H-imidazole (2E4MZ), 2-methyl-1H-imidazole (2MZ), 2-phenyl-1H-imidazole (2PZ), 1-benzyl-2-methyl-1H-imidazole (1B2MZ), 1-benzyl-2-phenyl-1H-imidazole (1B2PZ), (4-methyl-2-phenyl-1H-imidazol-5-yl)methanol (2P4MHZ), (2-phenyl-1H-imidazole-4,5-diyl)dimethanol (2PHZ), 6-(2-(2-methyl-1H-imidazol-1-yl)ethyl)-1,3,5-triazine-2,4-diamine (2MZ-A), 2,3-dihydro-1H-benzo[d]pyrrolo[1,2-a]imidazole (TBZ), pyridine, 2-methylpyridine, 3-methylpyridine, 4-methylpyridine, 2,6-dimethylpyridine and 1,3-dialkyl-1H-imidazol-3-ium salts, especially carboxylates, halides, sulphonates, nitrates, sulphates or hydrogensulphates.

“Phenolic amines” in the context of the invention are 4-dimethylaminomethylphenol, 2,6-di-tert-butyl-4-dimethylaminomethylphenol (Ionol® 103), 2,4,6-trisdimethylaminomethylphenol or 2,4-bisdimethylaminomethyl-6-methylphenol.

“Metal salts” in the context of the invention are zinc(II) acetylacetonate, (1-methylimidazolium)zinc(II) acetylacetonate [(1MZ)Zn(acac)₂], bis(1-methylimidazolium)iron(II) acetylacetonate [(1MZ)₂(Fe(acac)₂], tin octanoate or boron trifluoride complexes, especially etherates or complexes with ethylamine.

The present invention likewise provides for the use of hardener systems according to the present invention for hardening epoxy resin systems. The present invention further provides epoxy resin systems comprising at least one epoxy resin and at least one hardener system according to the present invention. The inventive hardener system has the advantage that it can be incorporated as such into the epoxy resins, without requiring addition of further auxiliaries, especially solvents. Preferably, the inventive epoxy resin system therefore does not contain any solvents. A further advantage of the present invention lies in the possibility of achieving hardening below the melting point of OPDA and, at the same time, given selection of suitable hardening cycles, of arriving at hardened, dimensionally stable systems having a high glass transition temperature, especially above 200° C.

In principle, there are no restrictions with regard to the epoxy resins to be used, meaning that it is also possible for mixtures of different epoxy resins to be present. Preferably, at least one epoxy resin having at least 2 epoxy groups per monomer is present. Said epoxy resin having at least 2 epoxy groups per monomer may be used alone or in a mixture with further epoxy resins.

Especially preferably, no aminic epoxy resins are present in the inventive epoxy resin system, as described, for example, in EP 0181337 or EP 1091992.

Examples of suitable epoxy resins are epoxy resins of the glycidyl ether type, which can be synthesized from bisphenol A or bisphenol F and epihalohydrins; epoxy resins of the glycidyl ester type, which can be synthesized from phthalic acid and epihalohydrins; alicyclic epoxy resins, which can be obtained by epoxidation from alicyclic dienes such as cyclopentadiene or cyclohexadiene; epoxidation products of unsaturated polymers, such as polybutadiene and polyisoprene; and polymers or copolymers of unsaturated monoepoxides, such as glycidyl methacrylate or allyl glycidyl ether. This enumeration is merely descriptive. For example, it is possible to use various polyhydric phenols rather than bisphenol A, or to use other polybasic acids rather than phthalic acid.

The proportion of the hardener system in the mixture with the epoxy resins is generally calculated from the ratio of the number of anhydride groups in the hardener system to the number of epoxy groups in the epoxy resins used. For every mole of epoxy group present in the epoxy resin used, 0.3-1 mol, more preferably 0.5-0.8 mol, most preferably 0.55-0.75 mol, of anhydride groups is used.

In the case of use of the inventive hardener system for hardening epoxy resins, several embodiments of equal value are conceivable.

In one embodiment of the invention, the above-described hardener system is first produced and then mixed with at least one epoxy resin. It is preferable in this embodiment that OPDA, OTA and at least one monoanhydride compound selected from the group consisting of MHHPSA, MNA, MTHPA, MFD, HFDPA, DMDF are present in the proportions by weight described above.

A significant advantage of this embodiment is that the user need merely combine the epoxy resin and the hardener system in the case of use in the manner of a two-component system. Separate storage of the individual components of the hardener system is not required, which leads to simplified applicability.

In a further embodiment of the present invention, it is possible at first for only a mixture of the at least one epoxy resin with OPDA and the at least one monoanhydride compound selected from the group consisting of MHHPSA, MNA, MTHPA, MFD, HFDPA, DMDF to be present, preferably in the weight ratios described above, to which the OTA, preferably in the proportions by weight described above, is subsequently added separately.

Overall, after addition of the OTA to the epoxy resin system, the inventive combination of the hardener system is then likewise present again.

For this purpose, OPDA is first mixed with at least one monoanhydride compound selected from the group consisting of MHHPSA, MNA, MTHPA, MFD, HFDPA, DMDF. This mixture is then added to the at least one epoxy resin. For the actual hardening, OTA is then added and the hardening is conducted. For the attainment of the advantage essential to the invention, what is important is merely that the inventive epoxy resin is present in the course of the actual hardening of the epoxy resins. The user is thus given the option of utilizing the advantages of the inventive hardener system, but at the same time of additionally gaining freedom with regard to the sequence of addition of the individual components.

Thus, methods for hardening epoxy resin systems are likewise aspects of the invention.

In a first aspect, this is a method for hardening epoxy resins, wherein

a combination of components comprising 5,5′-oxybis(isobenzofuran-1,3-dione) and a monoanhydride compound is added to the epoxy resin to obtain a first resin mixture;

4,4′-oxybis(ortho-phthalic acid) is added to the first resin mixture to obtain a final epoxy resin mixture; and

the final epoxy resin mixture is hardened at a temperature of at least 25° C.;

wherein the monoanhydride compound is selected from the group consisting of methylhexahydroisobenzofuran-1,3-dione, 5-methyl-3a,4,7,7a-tetrahydro-4,7-methanoisobenzofuran-1,3-dione, 5-methyl-3a,4,7,7a-tetrahydroisobenzofuran-1,3-dione, 3-methylfuran-2,5-dione, 3,3,4,4,5,5-hexafluorodihydro-2H-pyran-2,6(3H)-dione and 3,3-dimethyldihydrofuran-2,5-dione.

Preferably, the monoanhydride compound in the method of the first aspect of the invention is selected from the group consisting of MHHPSA, MTHPA, MNA. More preferably, the monoanhydride compound in the method of the first aspect of the invention is selected from the group consisting of MTHPA, MNA. Most preferably, the monoanhydride compound in the method of the first aspect of the invention is MTHPA.

In an advantageous embodiment of the method of the first aspect of the present invention, the ratio of the mass of OPDA used to the sum total of the mass of MHHPSA used, the mass of MNA used, the mass of MTHPA used, the mass of MFD used, the mass of HFDPA used, and the mass of DMDF used is 1:0.250 to 1:1.900, preferably 1:0.309 to 1:1.856, more preferably 1:0.412 to 1:1.546.

In a particularly advantageous embodiment of the method of the first aspect of the invention, the mass of OTA used in the method is 0.01% to 16.9% of the sum of the mass of OPDA used, the mass of MHHPSA used, the mass of MNA used, the mass of MTHPA used, the mass of MFD used, the mass of HFDPA used, and the mass of DMDF used.

In a preferred embodiment of the method of the first aspect of the invention, the mass of OTA used in the method is 0.025% to 10% of the sum of the mass of OPDA used, the mass of MHHPSA used, the mass of MNA used, the mass of MTHPA used, the mass of MFD used, the mass of HFDPA used, the mass of DMDF used.

In a more preferred embodiment of the method of the first aspect of the invention, the mass of OTA used in the method is 0.05% to 5% of the sum of the mass of OPDA used, the mass of MHHPSA used, the mass of MNA used, the mass of MTHPA used, the mass of MFD used, the mass of HFDPA used, the mass of DMDF used.

In an even more preferred embodiment of the method of the first aspect of the invention, the mass of OTA used in the method is 0.05% to 3% of the sum of the mass of OPDA used, the mass of MHHPSA used, the mass of MNA used, the mass of MTHPA used, the mass of MFD used, the mass of HFDPA used, the mass of DMDF used.

In a second aspect, this is a method for hardening epoxy resins, wherein

a hardener mixture comprising 5,5′-oxybis(isobenzofuran-1,3-dione), 4,4′-oxybis(ortho-phthalic acid) and a monoanhydride compound is prepared,

an epoxy resin is added to the hardener mixture to obtain an epoxy resin hardener mixture; and

the epoxy resin hardener mixture is hardened at a temperature of at least 25° C.,

wherein

the monoanhydride compound is selected from the group consisting of methylhexahydroisobenzofuran-1,3-dione, 5-methyl-3a,4,7,7a-tetrahydro-4,7-methanoisobenzofuran-1,3-dione, 5-methyl-3a,4,7,7a-tetrahydroisobenzofuran-1,3-dione, 3-methylfuran-2,5-dione, 3,3,4,4,5,5-hexafluorodihydro-2H-pyran-2,6(3H)-dione and 3,3-dimethyldihydrofuran-2,5-dione.

Preferably, the monoanhydride compound in the method of the second aspect of the invention is selected from the group consisting of MHHPSA, MTHPA, MNA. More preferably, the monoanhydride compound in the method of the second aspect of the invention is selected from the group consisting of MTHPA, MNA. Most preferably, the monoanhydride compound in the method of the second aspect of the invention is MTHPA.

In an advantageous embodiment of the method of the second aspect of the present invention, the ratio of the mass of OPDA used to the sum total of the mass of MHHPSA used, the mass of MNA used, the mass of MTHPA used, the mass of MFD used, the mass of HFDPA used, the mass of DMDF used is 1:0.250 to 1:1.900, preferably 1:0.309 to 1:1.856, more preferably 1:0.412 to 1:1.546.

In a particularly advantageous embodiment of the method of the second aspect of the invention, the mass of OTA used in the method is 0.01% to 16.9% of the sum of the mass of OPDA used, the mass of MHHPSA used, the mass of MNA used, the mass of MTHPA used, the mass of MFD used, the mass of HFDPA used, the mass of DMDF used.

In a preferred embodiment of the method of the second aspect of the invention, the mass of OTA used in the method is 0.025% to 10% of the sum of the mass of OPDA used, the mass of MHHPSA used, the mass of MNA used, the mass of MTHPA used, the mass of MFD used, the mass of HFDPA used, the mass of DMDF used.

In a more preferred embodiment of the method of the second aspect of the invention, the mass of OTA used in the method is 0.05% to 5% of the sum of the mass of OPDA used, the mass of MHHPSA used, the mass of MNA used, the mass of MTHPA used, the mass of MFD used, the mass of HFDPA used, the mass of DMDF used.

In an even more preferred embodiment of the method of the second aspect of the invention, the mass of OTA used in the method is 0.05% to 3% of the sum of the mass of OPDA used, the mass of MHHPSA used, the mass of MNA used, the mass of MTHPA used, the mass of MFD used, the mass of HFDPA used, the mass of DMDF used.

In the method according to the invention for hardening epoxy resin systems according to the first and second aspects above, the hardening may be effected at a temperature of at least 25° C., especially at a temperature of at least 50° C. The hardening may be effected, for instance, at a temperature in the range from 25° C. to below the melting temperature of the OPDA, especially at a temperature in the range from 25° C. to 200° C., preferably at a temperature in the range from 25° C. to 180° C. The melting temperature of the OPDA is in the range from 225° C. to 229° C.

The present invention is illustrated by the examples which follow, without being restricted thereto.

### EXAMPLES

### 1. Examples 1 (Inventive) and 2 (Comparative Example)

### Determination of the Gel Time at 170° C. To DIN EN 16 945, Sheet 1

### Example 1

In a 100 ml beaker, at room temperature, 7.1 g of OPDA, 2.9 g of OTA and 10.0 g of MNA (corresponding to a mass of OTA of 16.9% of the sum total of the mass of OPDA and the mass of MNA) were mixed with one another. Subsequently, a wooden spatula was used to incorporate 10 g of the cycloaliphatic epoxy resin CY179 having the following structural formula:

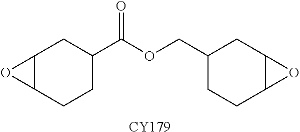 [SMILES: "CY179" ; O=C(OCC1CCC2OC2C1)C1CCC2OC2C1]

so as to form a homogeneous composition.

10 g of the mixture thus obtained were transferred into a test tube, then the gel time at 170° C. was determined to DIN EN 16945, Sheet 1. The gel time was 27.33 min.

### Example 2

For comparison, the experiment was repeated without OTA. To this end, 10.0 g of OPDA and 10.0 g of MNA were mixed with one another in a 100 ml beaker at room temperature. Subsequently, a wooden spatula was used to incorporate 10 g of the cycloaliphatic epoxy resin CY179 so as to form a homogeneous composition.

10 g of the mixture thus obtained were transferred into a test tube, then the gel time at 170° C. was determined to DIN EN 16945, Sheet 1. The gel time was 68.42 min.

This showed that a distinct reduction in the gel time was already observed in the case of very small proportions of OTA in the mixture. This is attributable to the accelerating and completely surprising property of the OTA.

### 2. Examples 3-24 (Inventive)

### Formulation

A 100 ml beaker was initially charged with 9.7 g of OPDA and 0.3 g of OTA. Thereafter, MTHPA or MNA was added stepwise in accordance with the amounts shown in Table 1 and the mixture was stirred at 23° C. for about one minute to give a homogeneous composition. Thereafter, the consistency was checked visually. Table 1 below indicates, in the penultimate column, the consistency of the mixture obtained in the case that the monoanhydride compound used was MTHPA (“MTHPA” column) and, in the last column, the consistency in the case that the monoanhydride compound used was MNA (“MNA” column). “Free-flowing” means that no paste was obtained; instead, the mixture was in pulverulent form. “Pasty” means that the homogeneous mixture was of spreadable consistency and remained homogeneous even over a long period, i.e. more than one hour, without the suspended solids content consisting of OTA and OPDA settling out. “Unstable” means that the mixture obtained was at first homogeneous but the suspended solids content consisting of OTA and OPDA settled out after less than one hour. The left-hand column in Table 1 indicates the number of the particular example. One example consists of two experiments in each case, with use of the appropriate amount of MTHPA in the first and of the appropriate amount of MNA in the second as the monoanhydride compound.

It is apparent from Table 1 that, in the case that MTHPA as the monoanhydride was used in combination with OPDA, an advantageous pasty structure is the result over a very broad mixing range. Thus, the disadvantageous free-flowing consistency was not found until a mixing ratio of OPDA:MTHPA of 1:0.206 or for even smaller proportions of MTHPA, while instability was not detected until a proportion of 1:1.959 or for even higher proportions of MTHPA. The corresponding range of values for MNA is much narrower: Thus, the disadvantageous free-flowing consistency was still found at a mixing ratio of OPDA:MNA of 1:0.361 or for even smaller proportions of MNA, while instability was already detected at a proportion of 1:1.649 or for even higher proportions of MNA. This broad range in which MTHPA could be mixed with OPDA and results in a structure of good processibility was completely surprising compared to the results in the case of the combination of OPDA and MNA.

TABLE 1

| | | | | Mixing ratio | | | |
|---|---|---|---|---|---|---|---|
| | OTA | OPDA | Monoanhydride | | Mono- | | |
| | [g] | [g] | [g] | OPDA | anhydride | MTHPA | MNA |
| 3 | 0.3 | 9.7 | 1.0 | 1.000 | 0.103 | free-flowing | free-flowing |
| 4 | 0.3 | 9.7 | 2.0 | 1.000 | 0.206 | free-flowing | free-flowing |
| 5 | 0.3 | 9.7 | 3.0 | 1.000 | 0.309 | pasty | free-flowing |
| 6 | 0.3 | 9.7 | 3.5 | 1.000 | 0.361 | pasty | free-flowing |
| 7 | 0.3 | 9.7 | 4.0 | 1.000 | 0.412 | pasty | pasty |
| 8 | 0.3 | 9.7 | 5.0 | 1.000 | 0.515 | pasty | pasty |
| 9 | 0.3 | 9.7 | 6.0 | 1.000 | 0.619 | pasty | pasty |
| 10 | 0.3 | 9.7 | 7.0 | 1.000 | 0.722 | pasty | pasty |
| 11 | 0.3 | 9.7 | 8.0 | 1.000 | 0.825 | pasty | pasty |
| 12 | 0.3 | 9.7 | 9.0 | 1.000 | 0.928 | pasty | pasty |
| 13 | 0.3 | 9.7 | 10.0 | 1.000 | 1.031 | pasty | pasty |
| 14 | 0.3 | 9.7 | 11.0 | 1.000 | 1.134 | pasty | pasty |
| 15 | 0.3 | 9.7 | 12.0 | 1.000 | 1.237 | pasty | pasty |
| 16 | 0.3 | 9.7 | 13.0 | 1.000 | 1.340 | pasty | pasty |
| 17 | 0.3 | 9.7 | 14.0 | 1.000 | 1.443 | pasty | pasty |
| 18 | 0.3 | 9.7 | 15.0 | 1.000 | 1.546 | pasty | pasty |
| 19 | 0.3 | 9.7 | 16.0 | 1.000 | 1.649 | pasty | unstable |
| 20 | 0.3 | 9.7 | 17.0 | 1.000 | 1.753 | pasty | unstable |
| 21 | 0.3 | 9.7 | 18.0 | 1.000 | 1.856 | pasty | unstable |
| 22 | 0.3 | 9.7 | 19.0 | 1.000 | 1.959 | unstable | unstable |
| 23 | 0.3 | 9.7 | 19.5 | 1.000 | 2.010 | unstable | unstable |
| 24 | 0.3 | 9.7 | 20.0 | 1.000 | 2.062 | unstable | unstable |

The above description is presented to enable a person skilled in the art to make and use the invention, and is provided in the context of a particular application and its requirements. Various modifications to the preferred embodiments will be readily apparent to those skilled in the art, and the generic principles defined herein may be applied to other embodiments and applications without departing from the spirit and scope of the invention. Thus, this invention is not intended to be limited to the embodiments shown, but is to be accorded the widest scope consistent with the principles and features disclosed herein. In this regard, certain embodiments within the invention may not show every benefit of the invention, considered broadly.

1. A composition comprising:
5,5′-oxybis(isobenzofuran-1,3-dione);
4,4′-oxybis(ortho-phthalic acid); and
a monoanhydride compound selected from the group consisting of methylhexahydroisobenzofuran-1,3-dione, 5-methyl-3a,4,7,7a-tetrahydro-4,7-methanoisobenzofuran-1,3-dione, 5-methyl-3a,4,7,7a-tetrahydroisobenzofuran-1,3-dione, 3-methylfuran-2,5-dione, 3,3,4,4,5,5-hexafluorodihydro-2H-pyran-2,6(3H)-dione and 3,3-dimethyldihydrofuran-2,5-dione.

2. The composition according to claim 1, wherein the monoanhydride compound is selected from the group consisting of methylhexahydroisobenzofuran-1,3-dione, 5-methyl-3a,4,7,7a-tetrahydroisobenzofuran-1,3-dione and 5-methyl-3a,4,7,7a-tetrahydro-4,7-methanoisobenzofuran-1,3-dione.

3. The composition according to claim 1, wherein the monoanhydride compound is at least one of 5-methyl-3a,4,7,7a-tetrahydroisobenzofuran-1,3-dione and 5-methyl-3a,4,7,7a-tetrahydro-4,7-methanoisobenzofuran-1,3-dione.

4. The composition according to claim 1, wherein the monoanhydride compound is 5-methyl-3a,4,7,7a-tetrahydroisobenzofuran-1,3-dione.

5. The composition according to claim 1, wherein a ratio of the mass of 5,5′-oxybis(isobenzofuran-1,3-dione) in the composition to the sum total of the mass of methylhexahydroisobenzofuran-1,3-dione, the mass of 5-methyl-3a,4,7,7a-tetrahydro-4,7-methanoisobenzofuran-1,3-dione, the mass of 5-methyl-3a,4,7,7a-tetrahydroisobenzofuran-1,3-dione, the mass of 3-methylfuran-2,5-dione, the mass of 3,3,4,4,5,5-hexafluorodihydro-2H-pyran-2,6(3H)-dione and the mass of 3,3-dimethyldihydrofuran-2,5-dione in the composition is 1:0.250 to 1:1.900.

6. The composition according to claim 1, wherein the mass of 4,4′-oxybis(ortho-phthalic acid) in the composition is from 0.01 to 16.9% of the sum total of the mass of 5,5′-oxybis(isobenzofuran-1,3-dione), the mass of methylhexahydroisobenzofuran-1,3-dione, the mass of 5-methyl-3a,4,7,7a-tetrahydro-4,7-methanoisobenzofuran-1,3-dione, the mass of 5-methyl-3a,4,7,7a-tetrahydroisobenzofuran-1,3-dione, the mass of 3-methylfuran-2,5-dione, the mass of 3,3,4,4,5,5-hexafluorodihydro-2H-pyran-2,6(3H)-dione and the mass of 3,3-dimethyldihydrofuran-2,5-dione in the composition.

7. A hardener system for epoxy resins, comprising the composition according to claim 1, wherein a proportion by mass of the composition of claim 1 is from 10% to 100% by mass, based on the total mass of the hardener system.

8. The hardener system according to claim 7, wherein the hardener system is free of any amine compound.

9. The hardener system according to claim 7, wherein the hardener system is free of any metal salt.

10. The hardener system according to claim 8, wherein the hardener system is free of any metal salt.

11. A method for hardening an epoxy resin, comprising mixing the hardener system according to claim 7 with the epoxy resin to be hardened.

12. The method for hardening an epoxy resin according to claim 11,
wherein
a combination of components comprising 5,5′-oxybis(isobenzofuran-1,3-dione) and a monoanhydride compound is added to the epoxy resin to obtain a first resin mixture;
4,4′-oxybis(ortho-phthalic acid) is added to the first resin mixture to obtain a final epoxy resin mixture; and
the final epoxy resin mixture is hardened at a temperature of at least 25° C.;
wherein the monoanhydride compound is selected from the group consisting of methylhexahydroisobenzofuran-1,3-dione, 5-methyl-3a,4,7,7a-tetrahydro-4,7-methanoisobenzofuran-1,3-dione, 5-methyl-3a,4,7,7a-tetrahydroisobenzofuran-1,3-dione, 3-methylfuran-2,5-dione, 3,3,4,4,5,5-hexafluorodihydro-2H-pyran-2,6(3H)-dione and 3,3-dimethyldihydrofuran-2,5-dione.

13. The method for hardening an epoxy resin according to claim 12, wherein the hardening temperature is from 25° C. to below the melting temperature of 5,5′-oxybis(isobenzofuran-1,3-dione).

14. The method for hardening an epoxy resin according to claim 11,
wherein
a hardener mixture comprising 5,5′-oxybis(isobenzofuran-1,3-dione), 4,4′-oxybis(ortho-phthalic acid) and a monoanhydride compound is prepared,
an epoxy resin is added to the hardener mixture to obtain an epoxy resin hardener mixture; and
the epoxy resin hardener mixture is hardened at a temperature of at least 25° C.,
wherein
the monoanhydride compound is selected from the group consisting of methylhexahydroisobenzofuran-1,3-dione, 5-methyl-3a,4,7,7a-tetrahydro-4,7-methanoisobenzofuran-1,3-dione, 5-methyl-3a,4,7,7a-tetrahydroisobenzofuran-1,3-dione, 3-methylfuran-2,5-dione, 3,3,4,4,5,5-hexafluorodihydro-2H-pyran-2,6(3H)-dione and 3,3-dimethyldihydrofuran-2,5-dione.

15. The method for hardening an epoxy resin according to claim 14, wherein the hardening temperature is from 25° C. to below the melting temperature of 5,5′-oxybis(isobenzofuran-1,3-dione).

16. An epoxy resin system, comprising:
an epoxy resin; and
a hardener system according to claim 7.
